(19) United States
(12) Patent Application Publication
(10) Pub. No.: US 2002/0093178 A1
(43) Pub. Date: Jul. 18, 2002

(54) Juvenile stroller with collapsible basket

(76) Inventors: Dennis M. Turner, Mooresville, IN (US); Andrew Mendenhall, Indianapolis, IN (US); Paul T. Zink, Anderson, IN (US)

Correspondence Address: BARNES & THORNBURG, 11 SOUTH MERIDIAN, INDIANAPOLIS, IN, 46204

(21) Appl. No.: 10/044,520

(22) Filed: Jan. 11, 2002

Related U.S. Application Data
(60) Provisional application No. 60/261,605, filed on Jan. 12, 2001.

(51) Int. Cl. B62B 7/00

(52) U.S. Cl. 280/650; 280/658

(57) ABSTRACT

A juvenile stroller includes a foldable stroller frame and a foldable container coupled to the stroller frame and configured to fold as the stroller frame is folded and unfold as the stroller frame is unfolded. The container is located under a seat coupled to the stroller frame. A front half of the container is coupled to front leg members included in the stroller frame and a rear half of the container is coupled to rear leg members included in the stroller frame. The rear half is coupled to the front half to pivot about a pivot axis relative to the front half during folding and unfolding of the stroller frame.

This application claims priority under 35 U.S.C. 119(e) to U.S. Provisional Application Ser. No. 60/261,605, filed Jan. 12, 2001, which is expressly incorporated by reference herein.

### BACKGROUND AND SUMMARY

The present disclosure relates to juvenile strollers, and particularly to stroller accessories. More particularly, the present disclosure relates to storage units adapted to be carried onboard a juvenile stroller.

Juvenile strollers are being adapted to carry various child-car items in handy onboard locations in addition to carrying infants and other young children. Caregivers appreciate the convenience of being able to store child-care items or other items needed by caregivers or siblings onboard the stroller so that those items will be available to the caregiver when the stroller is used to transport a child away from home or vehicle.

According to the present disclosure, a juvenile stroller includes a foldable stroller frame and a foldable container coupled to the foldable stroller and configured to fold as the stroller frame is folded and unfold as the stroller frame is unfolded. The foldable container includes a front half coupled to front leg members included in the stroller frame and a rear half coupled to the rear leg members included in the stroller frame. The rear half is coupled to the front half to pivot about a pivot axis relative to the front half during folding and unfolding of the stroller frame.

In one embodiment, the container is arranged to lie under a seat coupled to the foldable stroller frame. A pair of front slide rails mounted on the front half of the container mate with front slide rail receivers mounted on the front leg members. A pair of rear slide rails mounted on the rear half of the container mate with rear slide rail receivers mounted on the rear leg members. When the foldable stroller frame is moved to assume an expanded, use position, the container can be moved horizontally relative to the stroller frame to cause each front slide rail to mate with a companion front slide rail receiver and to cause each rear slide rail to mate with a companion rear slide rail receiver and to locate the pivot axis established by the pivotable coupling between the rear and front halves of the container under the seat coupled to the stroller frame.

Additional features of the disclosure will become apparent to those skilled in the art upon consideration of the following detailed description of certain embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a juvenile stroller in accordance with the present disclosure showing a foldable stroller frame, a seat and tray coupled to the stroller frame, and a foldable container coupled to the stroller frame and positioned to lie under the seat;

FIG. 2 is a perspective view of the foldable container of FIG. 1;

FIG. 3 is a sectional view taken along line 3-3 of FIG. 1 showing a first rear slide rail mounted on a rear half of the container and coupled to a first rear slide rail receiver mounted on a rear leg member included in the stroller frame;

FIG. 4 is a sectional view taken along line 4-4 of FIG. 1 showing a first front slide rail mounted on a front half of the container and coupled to a first front slide receiver mounted on a front leg member included in the stroller frame;

FIG. 5 is a perspective view of the foldable container similar to FIG. 2 with the pliable walls and floor and top cover that cooperate to form a basket removed to show a foldable basket support frame carrying two front slide rails and two rear slide rails and showing two separated stiffener plates associated with the basket floor;

FIG. 6 is a perspective view similar to FIG. 1 showing the stroller frame in a folded, storage position and also showing the container in a folded configuration under the seat; and

FIG. 7 is a side elevation view of the juvenile stroller shown in FIG. 6.

### DETAILED DESCRIPTION OF THE DRAWINGS

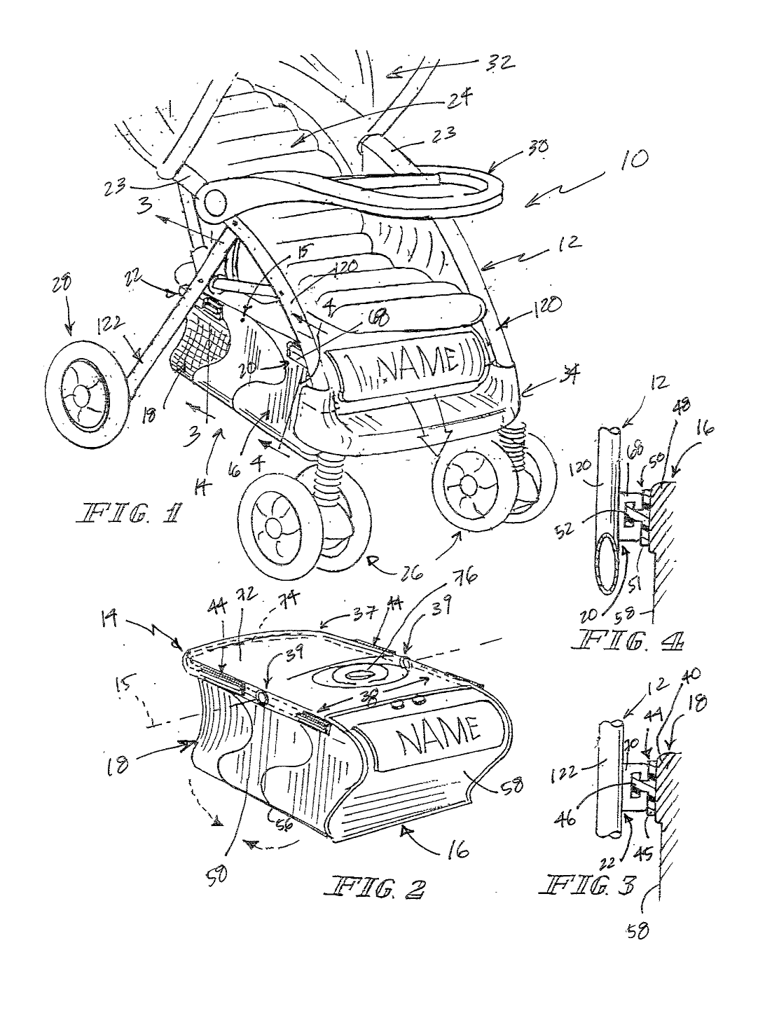

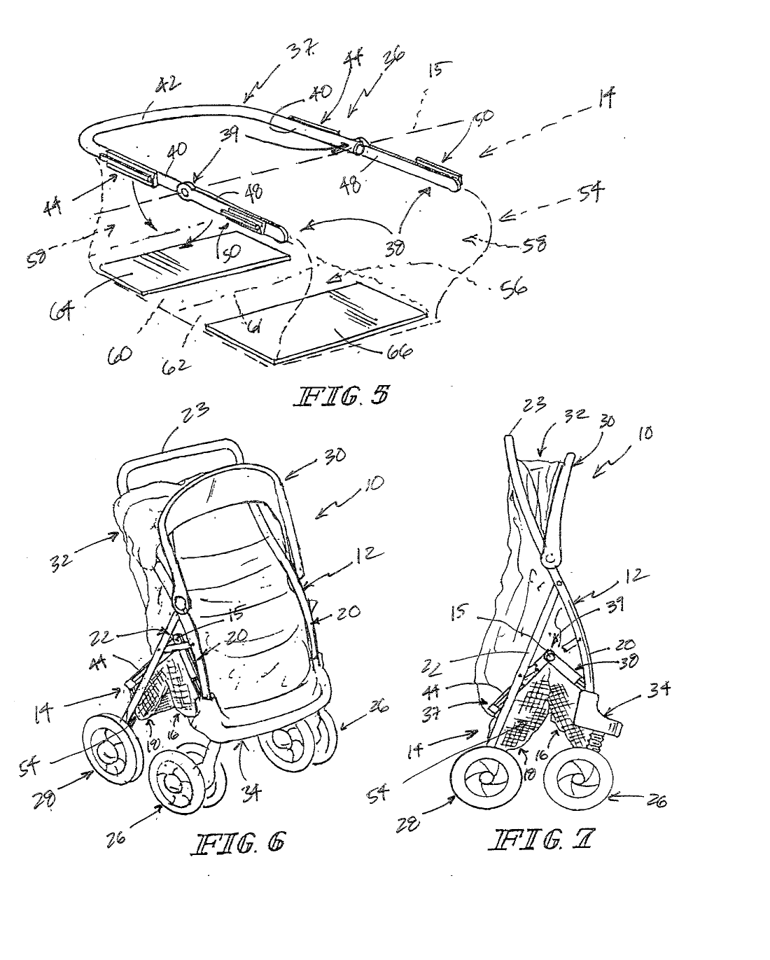

A juvenile stroller 10 includes a foldable stroller frame 12 and a foldable container 14 coupled to stroller frame 12. A front half 16 of container 14 is arranged to pivot about a pivot axis 15 and relative to a rear half 18 of container 14 to allow container 14 to fold as stroller frame 12 is unfolded to assume an expanded, use position shown, for example, in FIG. 1 and unfolded to assume a folded, storage position as shown, for example, in FIGS. 6 and 7. One embodiment of foldable container 14 is illustrated in FIG. 2 and various framing components included in such an illustrative container 14 are shown in FIG. 5.

Stroller frame 12 includes front legs 20, rear legs 22 arranged to move relative to front legs 20 as stroller frame 12 is moved between the expanded, use position and the folded, storage position, and a push handle 23. A seat 24 is coupled to stroller frame 12 in any suitable manner. It is within the scope of this disclosure to employ a wide variety of seats and frames.

A set of front wheels 26 is coupled to each front leg 20 and a rear wheel 28 is coupled to each rear leg 22. It is within the scope of this disclosure to provide an axle (not shown) coupled to each of the rear wheels 28. In the illustrated embodiment, a tray 30 and foldable canopy 32 are coupled to push handle 23 as shown best in FIGS. 6 and 7 and a footrest 34 is coupled to front legs 20 as shown best in FIGS. 1 and 7.

As suggested in FIG. 5, container 14 includes a foldable basket support frame 36 including a rear portion 37 adapted to be coupled to rear legs 22 to move therewith and a front portion 38 adapted to be coupled to front legs 20 to move therewith. Means 39 is provided for pivotably coupling rear portion 37 to front portion 38 so that rear portion 37 pivots about pivot axis 15 relative to front potion 38 during movement of foldable stroller frame 12 between the expanded, use position shown in FIGS. 1 and the folded, storage position shown in FIGS. 6 and 7.

Rear portion 37 of foldable basket support frame 36 includes a pair of spaced-apart rear side rims 40 and an end rim 42 interconnecting rear side rims 40 as shown, for example, in FIG. 5. Rear portion 37 further includes a rear slide rail 44 coupled to outboard sides of each of the rear side rims 40. In an illustrative embodiment, each rear slide rail 44 includes a base 45 coupled to one of the rear side rims 40 and a T-shaped rail section 46 appended to base 45 as suggested in FIG. 3. Each rear side rim 40 is also formed to include a pivot pin-receiving aperture as suggested in FIG. 5.

Front portion 38 of foldable basket support frame 36 includes a pair of spaced-apart front side rims 48 as shown, for example, in FIG. 5. Front portion 38 further includes a front slide rail 50 coupled to outboard sides of each of the front side rims 48. In an illustrative embodiment, each front side rail 50 includes a base 51 coupled to one of the front side rims 50 and a T-shaped rail section 52 appended to base 51 as suggested in FIG. 3. Each front side rim 50 is also formed to include a pivot pin-receiving aperture as suggested in FIG. 5.

As suggested in FIG. 5, in an illustrative embodiment, pivot means 39 includes a pivot pin arranged to extend through an aperture formed in each mated pair of rear and front side rims 40, 48. It is within the scope of this disclosure to use other pivots or couplings to establish a pivotable or otherwise movable coupling between the mated pairs of rear and front side rims 40, 48.

Foldable container 14 further includes a basket 54 coupled to the rear and front portions 37, 38 of foldable basket support frame 36 to move therewith as suggested in FIGS. 1, 2, and 7. Basket 54 includes a floor 56 and walls 58 made of a pliable material. At least some of walls 58 are coupled to side rims 40, 48 and arranged to change shape during movement of foldable stroller frame 12 between the expanded, use position shown in FIG. 1 and the folded, storage position shown in FIGS. 6 and 7. Floor 56 is coupled to walls 58 and is also configured to change shape during such folding movement of foldable stroller frame 12. Floor 56 includes a rear section 60 and a front section 62 separated from rear section 60 by a fold axis 61. A rear stiffener plate 64 is associated with rear section 60 of floor 56 and a front stiffener plate 66 is associated with front section 62 of floor 56 as suggested in FIG. 5. Front stiffener plate 66 is arranged to move relative to rear stiffener plate 64 upon folding of floor 56 about fold axis 61.

Each front leg 20 includes a front leg member 120 and a front slide rail receiver 68 coupled to the front leg member 120 as suggested in FIGS. 1, 4, and 7. Each front slide rail receiver 68 is configured to receive one of the front slide rails 50 therein. In an illustrative embodiment, front slide rail receiver 68 is formed to include a T-shaped channel sized to receive the matching T-shaped rail section 52 of front slide rail 50 for reciprocable sliding movement therein. The two front slide rail receivers 68 are arranged to extend in horizontal directions and lie in spaced-apart relation to one another when foldable stroller frame 12 is moved to assume the expanded, use position.

Each rear leg 22 includes a rear leg member 122 and a rear slide rail receiver 70 coupled to the rear leg member 122 as suggested in FIGS. 1, 4, and 7. Each rear side rail receiver 70 is configured to receive one of the rear slide rails 44 therein. In an illustrative embodiment, rear slide rail receiver 70 is formed to include a T-shaped channel sized to receive the matching T-shaped rail section 46 of rear slide rail 44 for reciprocable sliding movement therein. The two rear slide rail receivers 70 are arranged to extend in horizontal directions and lie in spaced-apart relation to one another when foldable stroller frame 12 is moved to assume the expanded, use position.

As shown in FIG. 2, basket 54 also includes a cover 72 and means for fastening cover 72 to walls 58 to open and close a top opening into an interior region formed in basket 54 and defined by walls 58 and floor 56. The fastening means includes a zipper 74 although it is within the scope of this disclosure to use snaps, buttons, clips, ties, hook-and-loop fasteners, or other suitable cover fasteners. A handle 76 is coupled to cover 72 to make it easy to carry container 14 when container 14 is separated from stroller frame 12. It is within the scope of this disclosure to provide container 14 with thermal insulation to store items therein in a temperature-controlled environment.

The slide rails 44, 50 and slide rail receivers 68, 70 cooperate to provide means for coupling foldable container 14 to front and rear leg members 120, 122 of foldable stroller frame 12 in response to sliding movement of foldable container 14 relative to foldable stroller frame 12 when foldable stroller frame 12 is arranged, for example, to assume the expanded, use position shown in FIG. 1. To install container 14 on stroller frame 12, it is necessary only to slide front slide rails 50 into front slide rail receivers 68 and to slide rear slide rails 44 into rear slide rail receivers 70. During folding and unfolding movement of foldable stroller frame 12, there will be some reciprocable sliding movement of front slide rails 50 in the mating front slide rail receivers 60 and also some reciprocable sliding movement of rear slide rails 44 in the mating rear slide rail receivers 70. The front slide rails 50 and slide rail receivers 68 cooperate to define a front connector arranged to couple front half 16 of container 14 to front leg members 120. The rear slide rails 44 and slide rail receivers 70 cooperate to define a rear connector arranged to couple rear half 18 of container 14 to rear leg members 122.

Container 14 is arranged to be removable from stroller frame 12. Container 14 can be removed from stroller frame 12 when stroller frame 12 is folded for placement in an automobile or other vehicle. Container 14 need not be unloaded prior to removal from stroller frame 12. Stroller 10 can be folded quickly to provide a caregiver with limited exposure to cold or rainy weather.

1. A juvenile stroller comprising
a foldable stroller frame including front legs and rear legs arranged to move relative to the front legs as the foldable stroller frame is moved between an expanded, use position and a folded, storage position,
a foldable basket support frame including a rear portion coupled to the rear legs to move therewith, a front portion coupled to the front legs to move therewith, and means for pivotably coupling the rear portion of the foldable basket support frame to the front portion of the foldable bracket support frame so that the rear portion pivots about a pivot axis relative to the front portion during movement of the foldable stroller frame between the expanded, use position and the folded, storage position, and
a basket coupled to the rear and front portions of the foldable basket support frame to move therewith.

2. The juvenile stroller of claim 1, wherein each of the front and rear portions includes a pair of slide rails and each of the front and rear legs includes a leg member and a slide rail receiver coupled to the leg member and configured to receive one of the slide rails therein to cause the front portion to be coupled to the front legs and the rear portion to be coupled to the rear legs.

3. The juvenile stroller of claim 2, wherein a first front slide receiver is coupled to a first of the front leg members and arranged to extend in a horizontal direction when the foldable stroller frame is moved to assume the expanded, use position and a second front slide rail receiver is coupled to a second of the front leg members and arranged to extend in a horizontal direction to lie in spaced-apart parallel relation to the first front slide rail receiver when the foldable stroller frame is moved to assume the expanded, use position.

4. The juvenile stroller of claim 3, wherein the first and second front slide rail receivers are positioned to lie between the first and second of the front leg members, the front portion of the basket support frame further includes a pair of spaced-apart front side rims coupled to the basket, and each of the slide rails included in the front portion of the basket support frame is coupled to one of the front side rims and arranged to mate with a companion one of the first and second front slide rail receivers.

5. The juvenile stroller of claim 3, wherein a first rear slide rail receiver is coupled to a first of the rear leg members and arranged to extend in a horizontal direction when the foldable stroller frame is moved to assume the expanded, use position and a second rear slide rail receiver is coupled to a second of the rear leg members and arranged to extend in a horizontal direction to lie in spaced-apart parallel relation to the first rear slide rail receiver when the foldable stroller frame is moved to assume the expanded, use position.

6. The juvenile stroller of claim 5, wherein the first and second front slide rail receivers are positioned to lie between the first and second of the front legs, the front portion of the basket support frame further includes a pair of spaced-apart front side rims coupled to the basket, each of the slide rails included in the front portion of the basket support frame is coupled to one of the front side rims and arranged to mate with a companion one of the first and second front slide rail receivers, the first and second rear slide rail receivers are positioned to lie between the first and second of the rear leg members, the rear portion of the basket support frame further includes a pair of spaced-apart rear side rims coupled to the basket, each of the slide rails included in the rear portion of the basket support frame is coupled to one of the rear side rims and arranged to mate with a companion one of the first and second rear slide rail receivers, and each of the rear side rims is pivotably coupled to one of the front side rims to establish the means for pivotably coupling the rear portion of the foldable basket support frame to the front portion of the foldable basket support frame.

7. The juvenile stroller of claim 2, wherein each of the front and rear portions of the foldable basket support frame further includes a pair of side rims coupled to the basket, each side rim carries one of the slide rails, and each of the side rims included in the rear portion of the foldable basket support frame is pivotably coupled to one of the side rims included in the front portion of the foldable basket support frame to establish the means for pivotably coupling the rear portion of the foldable basket support frame to the front portion of the foldable basket support frame.

8. The juvenile stroller of claim 2, wherein the slide rails included in the front portion of the basket support frame are positioned to lie in spaced-apart relation to one another and the slide rails included in the rear portion of the basket support frame are positioned to lie in spaced-apart relation to one another.

9. The juvenile stroller of claim 8, wherein the front portion of the basket support frame further includes a pair of spaced-apart front side rims coupled to the basket, each of the slide rails included in the front portion of the basket support frame is coupled to one of the front side rims, the rear portion of the basket support frame further includes a pair of spaced-apart rear side rims coupled to the basket, each of the slide rails included in the rear portion of the basket support frame is coupled to one of the rear side rims, and each of the rear side rims is pivotably coupled to one of the front side rims to establish the means for pivotably coupling the rear portion of the foldable basket support frame to the front portion of the foldable basket support frame.

10. The juvenile stroller of claim 1, wherein each of the front and rear portions of the foldable basket support frame includes a pair of side rims and each of the side rims included in the rear portion is pivotably coupled to one of the side rims included in the front portion to establish the means for pivotably coupling the rear portion of the foldable basket support frame to the front portion of the foldable basket support frame.

11. The juvenile stroller of claim 10, wherein the basket includes a floor and walls made of a pliable material, some of the walls are coupled to the side rims and arranged to change shape during movement of the foldable stroller frame between the expanded, use position and the folded, storage position, and the floor is coupled to the walls and arranged to change shape during movement of the foldable stroller frame between the expanded, use position and the folded, storage position.

12. The juvenile stroller of claim 11, wherein the basket further includes a cover and means for fastening the cover to the side walls to permit movement of the cover relative to the side walls to open and close a top opening into an interior region formed in the basket and defined by the side walls and the floor.

13. The juvenile stroller of claim 10, wherein the rear portion of the foldable basket support frame further includes an end rim coupled to a side wall of the basket and to each of the side rims included in the rear portion of the foldable basket support frame.

14. The juvenile stroller of claim 1, wherein the basket includes a side wall made of a pliable material and configured to change shape during movement of the foldable stroller frame between the expanded, use position and the folded, storage position, a floor coupled to the side wall and configured to fold about a fold axis parallel to said pivot axis during movement of the foldable stroller frame between the expanded, use position and the folded, storage position.

15. The juvenile stroller of claim 14, wherein the floor includes a rear section and a front section separated from the rear section by a fold axis and the basket further includes a rear stiffener plate associated with the rear section and a front stiffener plate associated with the front section and arranged to move relative to the rear stiffener plate upon folding of the floor about the fold axis.

16. A juvenile stroller comprising
a foldable stroller frame and
a foldable container coupled to the foldable stroller and configured to fold as the stroller frame is folded to assume a folded, storage position and to unfold as the stroller frame is unfolded to assume an expanded, use position, the foldable container including a front half coupled to one part of the foldable stroller frame and a rear half coupled to another part of the foldable stroller frame, and the rear half being coupled to the front half to pivot about a pivot axis relative to the front half during folding and unfolding of the stroller frame.

17. The juvenile stroller of claim 16, wherein the foldable stroller frame includes front legs and rear legs arranged to move relative to the front legs during folding and unfolding of the stroller frame, the front half of the container is coupled to the front legs to move therewith during folding and unfolding of the stroller frame, and the rear half of the container is coupled to the rear legs to move therewith during folding and unfolding of the stroller frame.

18. The juvenile stroller of claim 16, further comprising a seat coupled to the foldable stroller frame, the container being arranged to lie under the seat.

19. The juvenile stroller of claim 16, wherein the front half of the container includes a pair of spaced-apart front side rims coupled to said one part of the foldable stroller frame, the rear half of the container further includes a pair of spaced-apart rear side rims coupled to said another part of the foldable stroller frame, each of the rear side rims is pivotably coupled to one of the front side rims to establish said pivot axis.

20. A juvenile stroller comprising
a foldable stroller frame including front leg members and rear leg members arranged to move relative to the front leg members as the foldable stroller frame is moved between an expanded, use position and a folded, storage position,
a foldable container including a front half and a rear half coupled to the front half to pivot about a pivot axis relative to the front half during movement of the foldable stroller frame between the expanded, use position and the folded, storage position, and
means for coupling the foldable container to the front and rear leg members of the foldable stroller frame in response to sliding movement of the foldable container relative to the foldable stroller frame when the foldable stroller frame is arranged to assume the expanded, use position, the coupling means including a front connector arranged to couple the front half of the container to the front leg members and a rear connector arranged to couple the rear half of the container to the rear leg members.

21. The juvenile stroller of claim 20, wherein the front connector includes a front slide rail receiver coupled to each of the front leg members and front slide rails coupled to the front half of the container, each of the front slide rails is configured to mate with one of the front slide rail receivers, the rear connector includes a rear slide rail receiver coupled to each of the rear leg members and rear slide rails coupled to the rear half of the container, and each of the rear slide rails is configured to mate with one of the rear slide rail receivers.

22. The juvenile stroller of claim 20, wherein the coupling means includes a slide rail receiver coupled to each of the front and rear leg members and slide rails coupled to the container and configured to mate with the slide rail receivers.

23. The juvenile stroller of claim 22, wherein each slide rail has a T-shaped rail section and each slide rail receiver has a matching T-shaped cavity sized and shaped to slidably receive the T-shaped rail section therein.

24. A juvenile stroller comprising
a foldable stroller frame including front leg members and rear leg members arranged to move relative to the front leg members as the foldable stroller frame is moved between an expanded, use position and a folded, storage position,
a container, and
means for coupling the container to the front and rear leg members of the foldable stroller frame in response to sliding movement of the container relative to the foldable stroller frame when the foldable stroller frame is arranged to assume the expanded, use position.

25. The stroller of claim 24, wherein the coupling means includes a slide rail receiver coupled to each of the front and rear leg members and slide rails coupled to the container and configured to mate with the slide rail receivers.

26. The juvenile stroller of claim 25, wherein each slide rail has a T-shaped rail section and each slide rail receiver has a matching T-shaped cavity sized and shaped to slidably receive the T-shaped rail section therein.

27. The juvenile stroller of claim 25, wherein the container includes a pair of front side rims, a pair of rear side rims, each of the rear side rims being pivotably coupled to one of the front side rims, and a basket made of a pliable material and coupled to the front and rear side rims to move therewith during pivotable movement of the rear side rims relative to the front side rims in response to movement of the foldable stroller frame between the expanded, use position and the folded, storage position.

28. The juvenile stroller of claim 24, wherein the container includes a front half and a rear half pivotably coupled to the front half for movement about a pivot axis and the coupling means includes a front connector arranged to couple the front half of the container to the front leg members and a rear connector arranged to couple the rear half of the container to the rear leg members.

29. The juvenile stroller of claim 28, wherein the front connector includes a front slide rail receiver coupled to each of the front leg members and front slide rails coupled to the front half of the container, each of the front slide rails is configured to mate with one of the front slide rail receivers, the rear connector includes a rear slide rail receiver coupled to each of the rear leg members and rear slide rails coupled to the rear half of the container, and each of the rear slide rails is configured to mate with one of the rear slide rail receivers.
